(19) United States
(12) Patent Application Publication
(10) Pub. No.: US 2015/0064673 A1
(43) Pub. Date: Mar. 5, 2015

(54) BEHAVIORAL ORGANIZATION SYSTEMS

(71) Applicants: Katherine Irene Bassett, Lehi, UT (US); Dustin Matthew Bassett, Lehi, UT (US)

(72) Inventors: Katherine Irene Bassett, Lehi, UT (US); Dustin Matthew Bassett, Lehi, UT (US)

(21) Appl. No.: 14/473,625

(22) Filed: Aug. 29, 2014

Related U.S. Application Data
(60) Provisional application No. 61/872,014, filed on Aug. 30, 2013.

(51) Int. Cl. G09B 29/00

(52) U.S. Cl. CPC G09B 29/001
USPC 434/238

(57) ABSTRACT

A motivational system for family organization and methods of using the system are described. The system allows for parents to assist children in fulfilling their responsibilities, setting and achieving goals, and learning values. The system is adaptable to each family's own value system and particular circumstances. Completion of tasks and progress towards goals is easily monitored by parents. The system uses a leveling system to categorize tasks and permits children to progress through levels of tasks. The system also possesses an integrated reward system to encourage task completion and progress towards goals while allowing children to have some choice in the rewards that they receive.

### CROSS-REFERENCE TO RELATED APPLICATIONS

This application claims priority to U.S. Provisional Patent Application No. 61/872,014, filed Aug. 30, 2013, titled Do Dots Family System and Kit. This patent application claims the benefit of this provisional application. The disclosure of the provisional application to which the present application claims priority is incorporated by reference.

This utility application is related to U.S. design application also entitled “Behavioral Organization Systems” which is incorporated herein by reference, and having been filed concurrently with the present utility application.

### BACKGROUND

Families and other organizations have a need for motivational systems and methods that allow for children or other participants to accomplish regular chores or tasks, to set and attain goals, to visually monitor progress, and to provide a reward system for task or goal completion. Parents or other organization leaders need motivational systems that allow for the parents or other organization leaders to assist children or other participants in fulfilling responsibilities and accomplishing tasks independently while teaching values and lessening the administrative burden on the parents and organizers. It would be desirable for such motivational systems to be flexible to allow for adaptation to each family's or organization's own value system. Also, it would be desirable that such motivational systems would be flexible to allow for modification to match children's or participant's changing maturity and experience levels. Other desirable features would include the ability for parents or organizers to clearly identify desired behaviors, provide incentives for such desired behaviors, and disincentives for behavior that is not desired. Yet another desirable feature would be an integrated reward system to reinforce task completion, goal attainment, and good behavior with the reward system allowing the child or participant to have some choice in the rewards.

Many techniques have been employed to attempt to address the motivational system problem. These techniques include the use of chore charts, task management charts, goal charts or other behavior management charts. These techniques can also include different versions of task management systems that incorporate charts that list regular chores, printable charts, or charts that use stickers, marbles, popsicle sticks, or other tokens to track tasks and responsibilities, task completion or goal progress. These techniques can also include reward or punishment systems. In many cases, these techniques do not produce desirable results and are not adaptable to a wide range of family or organization circumstances.

One particular motivational system that is known is a printable chore chart that a parent or organizer generates. The parent or organizer prepares a printed chart for each individual child or participant. The printed chart lists the regular tasks that the child or participant needs to complete and as the child or participant completes the tasks, the printable chart is marked to record that the task has been completed. Task completion can be recorded by marking the chart or by affixing stickers to the chart to represent the completion of individual tasks by the participant. Once the tasks on the printed chart have been completed, the child or participant receives a reward.

Although, printable chore charts can serve as a motivational system, there are a number of drawbacks. In particular, the system suffers from high maintenance in that the parents or organizers must recreate and print new chore charts on a regular basis. Also, the system requires multiple charts because an individual chart must be generated for each child or participant. Other drawbacks that printable chore charts and other motivational systems suffer from include but is not limited to failing to provide sufficient motivation for children or participants, being cumbersome to implement by parents, failing to teach values to children or participants, not being adaptable to children or participants of different maturity and experience levels, failing to allow parents or organizers to participate as participants, and failing to have a flexible reward system that correlates task completion with rewards and that allows the child or participant some choice in the rewards.

### BRIEF SUMMARY

The present disclosure is generally directed to a motivational system for family organization and to methods of using such a system. The motivational system allows for children or other participants to accomplish regular chores or tasks and to set and achieve goals. Parents or other organizers are able to use the system to assist children or other participants in fulfilling the children's or participant's responsibilities while learning to accomplish tasks independently. Parents are also able to help children set goals and learn values by assigning tasks that will help the children progress towards goals or progress towards learning values. The motivational system also makes it easier for parents and children or for organizers and participants by providing a visual method to keep track of assigned tasks, completed tasks, goals, and progress towards goals. The system is also adaptable to each family's or organization's own value systems and particular circumstances. The system can also be adapted to match children's or participant's different ages and maturity levels. The system allows for parents or organizers to clearly identify desired behaviors and to provide incentives for these desired behaviors. Likewise, incentives can be created to prevent undesirable behaviors. Lastly, the system integrates a reward system to reinforce task completion, goal attainment, and good behavior while allowing the child or participant to have some choice in the rewards that he or she receives.

In one embodiment, the motivational system for family organization comprises a visual status board configured to visually depict a plurality of participants, a plurality of tasks, a plurality of completions of tasks, and a plurality of tickets. The systems also includes a plurality of tokens configured to interact with the visual status board with the tokens configured to represent a plurality of participants, a plurality of tasks, a plurality of completion of tasks, and a plurality of tickets. The system has a leveling system configured to index the plurality of tasks into a plurality of categories. Additionally, the system includes a ticket economy that allows participants to earn tickets by completing tasks and allows participants to exchange tickets for prizes. The visual status board is configured to interact with the plurality of tokens to continuously track the plurality of participants, the plurality of tasks, the plurality of completions of tasks, and the plurality of tickets.

In another embodiment, the present application discloses a method for motivating a participant. First, the method includes providing a visual status board configured to visually depict a plurality of participants, a plurality of tasks, a plurality of completions of tasks, and a plurality of tickets. Second, the method includes providing a plurality of tokens configured to interact with the visual status board with the tokens configured to represent a plurality of participants, a plurality of tasks, a plurality of completion of tasks, and a plurality of tickets. Third, the method includes providing a leveling system configured to index the plurality of tasks into a plurality of categories. Fourth, the method includes providing a ticket economy where participants can earn tickets by completing tasks and where participants can exchange tickets for prizes. Fifth, the method includes tracking the plurality of participants, the plurality of tasks, the plurality of completions of tasks, and the plurality of tickets by manipulating the interaction of the plurality of tokens with the visual status board. Sixth, the method includes allocating tickets to participants. Lastly, the method includes redeeming tickets for prizes.

In alternate embodiment, the present application discloses a kit for a motivational system for family organization, comprising a visual status board configured to visually depict a plurality of participants, a plurality of tasks, a plurality of completions of tasks, and a plurality of tickets. The kit also includes a plurality of tokens configured to interact with the visual status board where the tokens are configured to represent a plurality of participants, a plurality of tasks, a plurality of completion of tasks, and a plurality of tickets. The kit further includes a plurality of tickets. The visual status board is further configured to interact with the plurality of tokens to continuously track the plurality of participants, the plurality of tasks, the plurality of completions of tasks, and the plurality of tickets.

This summary is provided to introduce a selection of concepts in a simplified form that are further described below in the Detailed Description. This Summary is not intended to identify key features or essential features of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example system that organizers can use as a motivational system for participants;

FIG. 2 illustrates several views of example tokens;

FIG. 3 illustrates a front view of example tickets;

FIG. 4 illustrates a method for setting up an example system;

FIG. 5 illustrates a method for using an example system;

FIG. 6 illustrates a method for using an example system and in particular a store.

### DETAILED DESCRIPTION

The present disclosure is generally directed to a motivational system for family organization and to methods of using such a system. The motivational system allows for children or other participants to accomplish regular chores or tasks and to set and achieve goals. Parents or other organizers are able to use the system to assist children or other participants in fulfilling the children's or participant's responsibilities while learning to accomplish tasks independently. Parents are also able to help children set goals and learn values by assigning tasks that will help the children progress towards goals or progress towards learning values. The motivational system also makes it easier for parents or organizers by providing a visual method to keep track of assigned tasks, completed tasks, goals, and progress towards goals. The system is also adaptable to each family's or organization's own value systems and particular circumstances. The system can also be adapted to match children's or participant's different ages and maturity levels. The system allows for parents or organizers to clearly identify desired behaviors and to provide incentives for these desired behaviors. Likewise, incentives can be created to prevent undesirable behaviors. Lastly, the system integrates a reward system to reinforce task completion, goal attainment, and good behavior while allowing the child or participant to have some choice in the rewards that he or she receives.

In one embodiment, the present disclosure is implemented as a motivational system for a family or organization. The system comprises a visual status board to record participant's tasks, completion of tasks, goals, progress towards achieving goals and accumulation of rewards. The system also includes tokens to identify participants and tokens to identify tasks or goals. The participant tokens and task tokens are arranged on the visual status board to indicate the particular tasks that are assigned to each participant. The system also comprises a leveling system to prioritize and/or categorize tasks that participants must complete. The leveling system allows for parents or organizers to index tasks into specific levels corresponding to specific categories of tasks. Individual levels can also be further divided into sub-levels. The leveling system can be used to divide tasks into levels corresponding to regular tasks such as daily tasks, weekly tasks, and/or longer term goals.

As participants complete tasks, tokens are used to record the completed tasks on the visual status board. As participants complete tasks they can advance to subsequent levels in the leveling system and can earn tickets. As participants earn tickets, the tickets are recorded with tokens on the visual status board. The tokens are then exchanged for tickets of different denominations. On a regular basis, the parents or organizers open a store where participants can exchange tickets for real world prizes. The store is stocked by the parents or organizers with prizes such as small toys or other suitable items or coupons for activities. The prizes can vary in ticket value and can be adapted to the age and maturity of the participants.

Although the present disclosure is generally directed to a motivational system for family organization and methods of using such a system, the system may be adapted to any organization where there is a need for organizers to motivate and reward participants. For example, the system can be adapted to the needs of a teacher seeking to motivate and reward students. The system can also be adapted to a business organization where employers seek to motivate and reward the efforts of employees. Other non-limiting applications of the system include youth sports organizations, nursing homes, group care facilities, rehabilitation facilities, Cub Scouts packs, Boy Scout troops, Girl Scout troops and church youth groups.

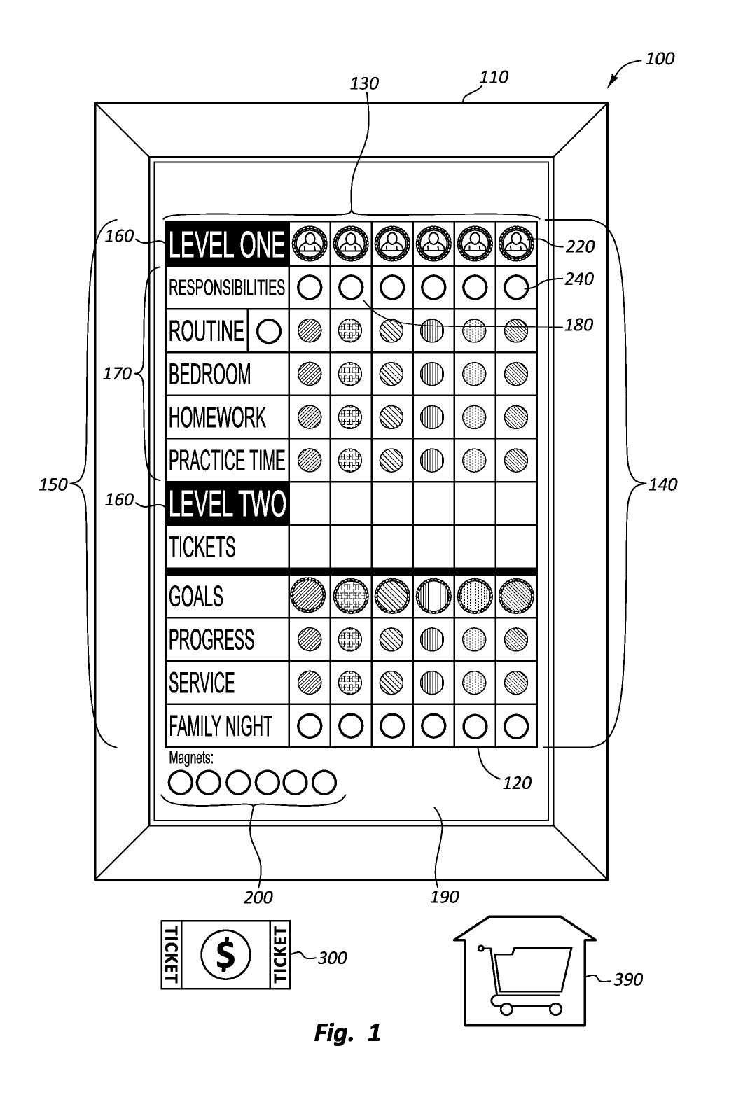

FIG. 1 illustrates an example system 100 that organizers can use as a motivational system for participants. System 100 includes a visual status board 110 that records participant's tasks, completion of tasks, and accumulation of rewards. The visual status board 110 comprises a graphical grid system 120 configured with a participant axis 130 and task axis 140. The task axis 140 can be further divided by a leveling system 150 that groups tasks into levels 160. Each level 160 can be configured to index a specific category of tasks. Each level 160 can be further divided into sub-levels 170 that index specific categories or sub-categories of tasks. The system 100 further comprises tokens 200 configured to detachably attach to the visual status board 110. The tokens 200 are divided into participant tokens 220 that identify individual participants and task tokens 240 that identify individual tasks. Participant tokens 220 are arranged along the participant axis 130. Task tokens 240 are arranged along the task axis 140. Participant tokens 220 corresponding to the participants can be used to record the completion of tasks. To record the task's completion, a participant token 220 corresponding to the participant that completed the task can be placed on the graphical grid system 120 at the intersection of the respective participant and task axes 180. Participant tokens 220 can also be used to record accumulation of rewards by participants. Participant tokens 220 accumulated as rewards can be exchanged for tickets 300. Tickets 300 can be redeemed by the participants at a store 390 for real-world prizes.

In some embodiments, the visual tracking board 110 comprises a flat substrate with the graphical grid system 120 printed on a flat surface. The flat substrate may comprise cardboard sheeting, metal sheeting, plastic sheeting, vinyl sheeting or any other suitable material. In some embodiments, the flat substrate comprises a ferrous metal configured to attract magnetic materials. In alternate embodiments, the flat substrate is a flat surface of an appliance such as a refrigerator. In other embodiments, the flat substrate comprises an erasable surface. In yet other embodiments, the flat substrate comprises a surface compatible with attaching hook-and-loop fasteners. In some embodiments, the graphical grid system 120 can be preprinted onto the visual status board 110. In other embodiments, the participant axis 130 can be aligned along the x-axis and the task axis 140 can be aligned along the y-axis. In alternate embodiments, the task axis 140 can be aligned along the x-axis and the participant axis 130 can be aligned along the y-axis. In yet other embodiments, the graphical grid system 120 can be configured such that a cut-out hole or a peg is at an intersection of each participant and task axis 180 to allow for selectably coupling a corresponding token configured with a peg or a cut-out hole. In some embodiments, the graphical grid system 120 is configured such that there is a storage space 190 for unused tokens 200.

In some embodiments, the leveling system 150 groups tasks into levels 160 that are hierarchal in nature with a plurality of levels 160 that increase in difficulty. In other embodiments, the hierarchal plurality of levels 160 are configured such that the tasks of a lower level 160 must be completed before the tasks of a subsequent level 160 may be completed. In alternate embodiments, the tasks of a lower level 160 must be completed before the participant is eligible to receive rewards. In yet another embodiment, the tasks of one level 160 represent tasks that must be done with more regularity such as daily tasks and another level 160 represents tasks that are to be completed over a longer time span such as weekly or monthly tasks. In another embodiment, one level 160 can be dedicated to recording the earned rewards of the participants. In alternate embodiments, levels 160 can be configured to track participant progress towards tasks and goals that represent values or attributes.

In some embodiments, the sub-levels 170 can be used to index a level 160 into sub-categories. For example, a level 160 that indexes daily tasks can be further divided into sublevels 170 that include tasks such as every day responsibilities, daily routine tasks, bedroom upkeep tasks, homework tasks, and practice time tasks. In other embodiments, a level that indexes weekly tasks can be further divided into sublevels 170 that include tasks such as weekly goals, progress toward long term goals, weekly service tasks, and tasks related to family night activities. In alternate embodiments, sublevels 170 can include tasks that relate to a certain area of the home. For example, the sublevels 170 can be divided into categories such as kitchen, living room, dining room, basement, and garage. Participants would then be responsible for completing all tasks corresponding to those specific areas that they have been assigned. Alternatively, sub-levels 170 can be divided into task categories such as cooking, laundry, yard work, and vacuuming. In this example, each participant is responsible for all of the tasks related to the task category that he or she has been assigned. In yet other embodiments, one of the levels 160 or sub-levels 170 can be used to track charitable contributions by participants. Task tokens 240 corresponding to charitable contributions can be used to track and record participant's charitable contributions. For example, as participants make a charitable contribution in the form of a donation or tithing, the completed task can be recorded in the system 100.

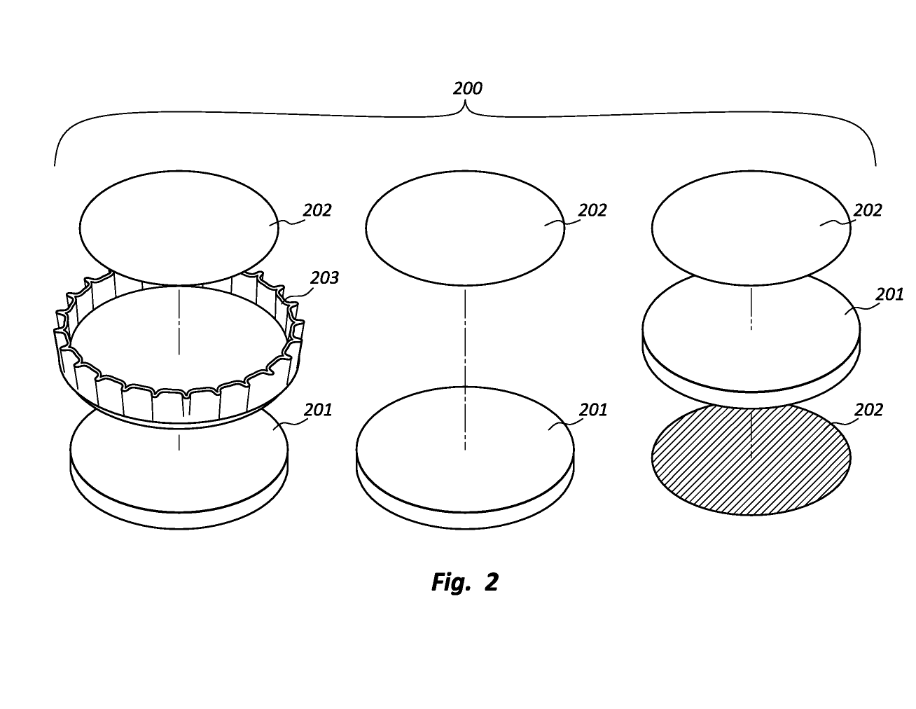

FIG. 2 illustrates several views of example tokens 200. In some embodiments, an example token 200 comprises a flat substrate that acts as a base 201 and a label 202. The label 202 is affixed to a flat surface of the base 201. In other embodiments, an example token 200 further comprises a framing disk 203 that is interleaved between the base 201 and the label 202. The framing disk 203 is affixed to the base 201 and the label 202 is affixed to the framing disk 203. In some embodiments, the base 201 can comprise metal, wood, plastic, cardboard, or other suitable materials. In another embodiment, the base 201 comprises a magnet configured to detachably attach to a visual status board 110 that is comprised of a ferrous metal configured to attract magnetic materials. In other embodiments, the base 201 is configured to detachably attach to the visual status board 110 by means of an adhesive that allows for repeated attachment and removal. In some embodiments, the base 201 is configured to detachably attach to the visual status board 110 by means of hook-and-loop material.

In some embodiments, the label 202 can comprise a small photo or caricature of a participant. In other embodiments, the label 202 can comprise a sticker that is affixed to the base 201. In alternate embodiments, labels 202 can be affixed to both sides of the base 201. In this example each side of the token 200 can represent different tasks or stages of completion of the task. For example one side of the token 200 may represent an uncompleted task and the other side can represent a completed task. Thus, to indicate completion of the task, the token can be turned over when the task is completed to reveal the “completed” label. In other embodiments, the label 202 can comprise an icon drawing that represents individual participants or an icon drawing that represents a particular task. For example, a participant may choose a drawing of an owl to identify his or her participant token 220 or a drawing of a toilet on the label 202 can be used to create a task token 240 corresponding to cleaning the bathroom. The icon drawings can include any shapes, symbols, or logos. In other embodiments, the labels 202 can be configured to be labeled by hand in either permanent or erasable ink. In other embodiments, the labels 202 can be configured to be marked with Braille writing. In alternate embodiments, the base 201 can be labeled directly with pencil, ink, paint, or other suitable marking. In yet other embodiments, the framing disk 203 can comprise cardboard, plastic, metal or other suitable materials. For example the framing disk 203 can be configured as a stylized soda bottle cap or other ornamental design that will further individualize tokens 200. In alternate embodiments, the tokens 200 can comprise decorative objects to identify participants or tasks and can include decorative magnets, decorative objects to represent a favorite sport or activity, or a holiday-themed magnet.

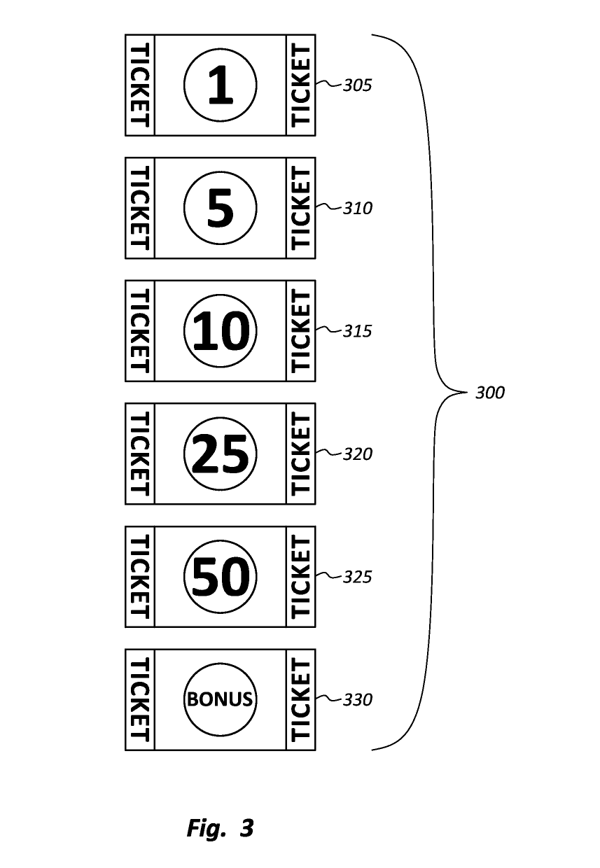

FIG. 3 illustrates a front view of example tickets 305, 310, 315, 320, 325, and 330 used in system 100. In some embodiments, the tickets 300 comprise cardboard sheets that are printed with various colors and ornamental designs. The tickets can comprise cardboard sheets, paper sheets, plastic sheets, tokens, marbles, popsicle sticks or any other suitable material. Ticket 305 has the denomination amount of one point. Ticket 310 has the denomination amount of five points. Ticket 315 has the denomination amount of ten points. Ticket 320 has the denomination amount of twenty five points. Ticket 325 has the denomination amount of fifty points.

Ticket 330 is a bonus ticket that can be assigned a special value by the organizer to correspond to a special reward or prize. Bonus tickets can also be used by parents or organizers to specifically reward one type of behavior. Bonus tickets may also be used to track a particular privilege that the parent or organizer wants to more closely monitor. These particular privileges may include time spent watching television or time spent playing video games. Additionally, bonus tickets may be redeemed by the participants to exempt the participant from certain required tasks. In other embodiments, bonus tickets may be used to determine a participant's weekly allowance.

In other embodiments, the tickets 300 can be assigned other denominations or can be assigned to correspond to certain rewards or prizes. In alternate embodiments the tickets 300 can be assigned a conversion value and can be redeemed by participants for legal currency.

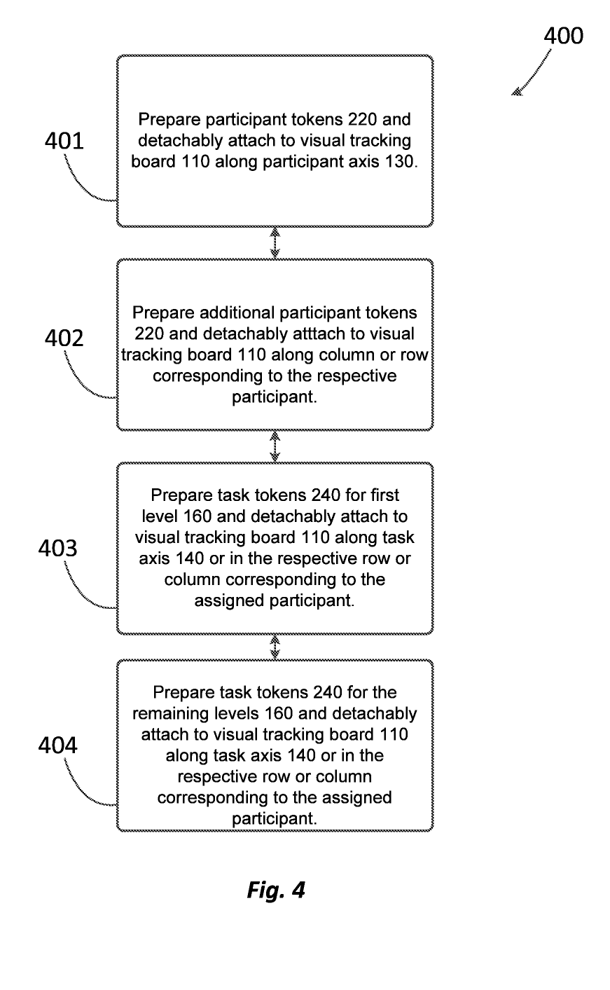

FIG. 4 illustrates method 400 for setting up the example system 100. Step 401 includes preparing participant tokens 220 and detachably attaching the participant tokens 220 to the visual tracking board 110 along the participant axis 130. Step 402 includes preparing other participant tokens 220 and detachably attaching the participant tokens 220 to the visual tracking board along the column or row that corresponds to the participant. In some embodiments, participant tokens 220 with participant photos or names are detachably attached to the participant axis 130 and participant tokens 220 that are color coded are detachably attached along the column or row that corresponds to the respective participant. Step 403 includes preparing the task tokens 240 for the first level 160 and detachably attaching the task tokens 240 along the task axis 140 or in the respective row or column corresponding to the assigned participant. In some embodiments, the sub-categories of the sub-level 170 are preprinted along the task axis 140 and the task tokens are detachably attached along the row or column of the corresponding sub-category. For example, preprinted sub-categories of the sub-level 170 can include responsibilities, routine, bedroom tasks, homework, and practice time. Task tokens 240 corresponding to responsibilities may include cleaning the kitchen, caring for the family pet, cooking, yard work or other regular responsibilities. Task tokens 240 corresponding to practice time can include practicing piano, practicing art, practicing soccer, or other activities that require regular practice.

Step 404 includes preparing and detachably attaching task tokens 240 for remaining levels 160 and sub-levels 170. In some embodiments, the remaining levels can include a level 160 to record tickets 300 earned by participants. In another embodiment, the remaining levels can include a level 160 dedicated to track participant progress towards tasks and goals that represent values or attributes. For example, the level 160 can include sub-levels 170 corresponding to participant goals, progress towards these goals, service activities, and family night activities.

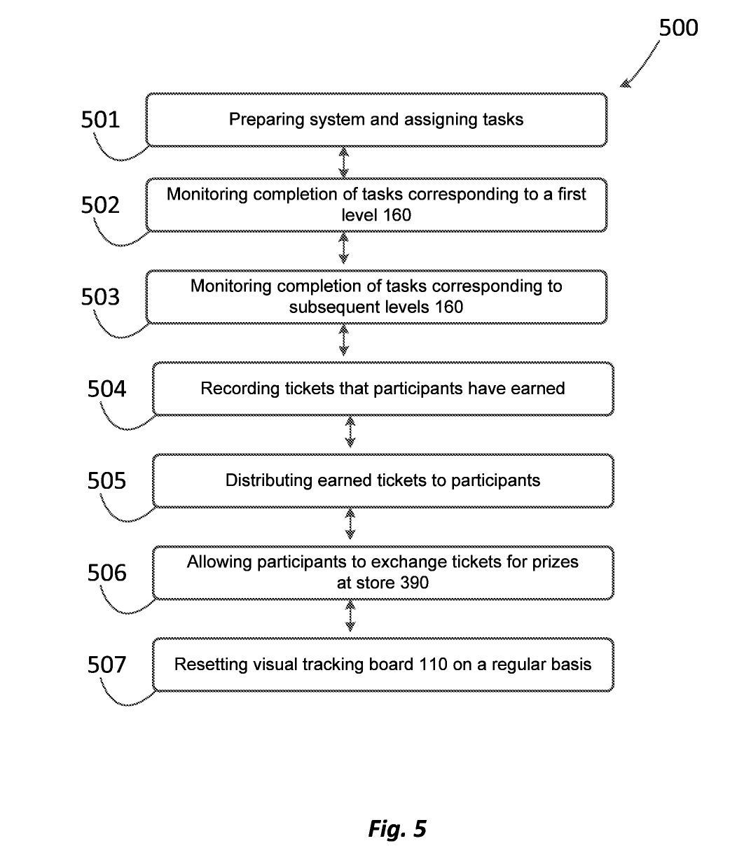

FIG. 5 illustrates a method 500 for using example system 100. Step 501 includes preparing the system 100 according to the method of 400 including assigning tasks to participants for each of the levels 160 and respective sub-levels 170. In some embodiments, individualized tasks are assigned to participants within each of the levels 160 or sub-levels 170. Step 502 includes monitoring completion of tasks corresponding to a first level 160 and recording the completion of tasks on the visual tracking board 110. In some embodiments, as tasks are completed, participant tokens 220 are placed at the respective intersection of each participant and task axis 180. In other embodiments, participant tokens 220 are initially detachably attached with the label 202 face-down and against the visual tracking board 110. As tasks are completed, the participant tokens 220 are inverted to reveal the label 202 to visually indicate that the individual task has been completed. In other embodiments, once a task is completed, the respective participant token is detachably attached onto the respective task token 240 to indicate that the task has been completed. Step 503 includes monitoring completion of tasks corresponding to subsequent levels 160 and recording the completion of tasks on the visual tracking board 110. Monitoring and task completion can be carried out in the same manner as in Step 502. In some embodiments, a participant's photo token 220 is moved to the row corresponding to the row or column for a subsequent level once the participant has completed the tasks of the previous level. In other embodiments, the participant can advance to a subsequent level 160 by earning a certain number of tickets.

Step 504 includes recording the tickets that the participants have earned by completing tasks. In some embodiments, a level 160 is dedicated to recording tickets that participants earn. For example participant tokens can be detachably attached to the level 160 dedicated to recording tickets to represent each ticket that a participant earns. In other embodiments, tickets that are earned can be recorded on another portion of the visual tracking board 110. In alternate embodiments, the organizer configures the leveling system 150 such that the tasks of a first level 160 must be completed before participants are eligible to earn tickets. In yet other embodiments, the organizer configures the leveling system 150 such that completion of a first level 160 enables the participants to earn other privileges such as being able to play with friends, watch television, play video games, or other suitable privileges. Step 505 includes distributing earned tickets 300 to participants. In some embodiments, each participant then stores his or her tickets in a dedicated envelope. In other embodiments, the visual tracking board 110 is configured to store each participant's tickets.

Step 506 includes allowing each participant to exchange his or her stored tickets for real world prizes at the store 390. In some embodiments, the organizer only allows participants to exchange tickets at the store 390 on a regular basis, such as a weekly. In other embodiments, the organizer assigns a ticket value to each prize and participants must accumulate tickets to exchange for prizes with higher ticket values. Step 507 includes resetting the visual tracking board 110 on a regular basis by reassigning tasks and/or removing the corresponding participant tokens. In some embodiments, the tasks corresponding to daily tasks are reset daily to allow participants to complete the daily tasks the following day. This can be done by inverting the tokens to hide the label 202 or by removing the participant tokens 220. In other embodiments, the levels 160 corresponding to daily tasks are reset daily and the levels 160 corresponding to weekly tasks are reset weekly.

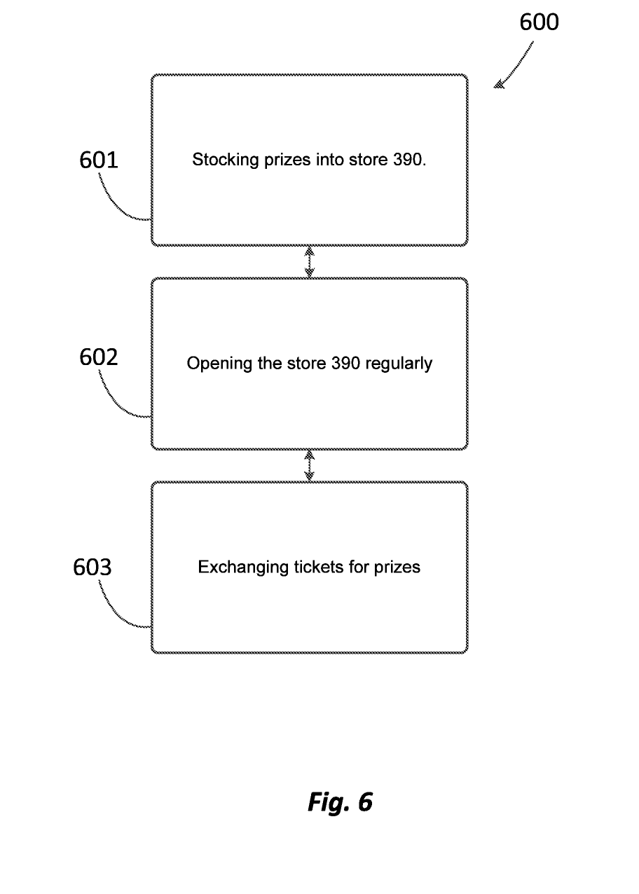

FIG. 6 illustrates a method 600 for using example system 100 and in particular store 390. Step 601 includes stocking prizes in the store. In some embodiments, prizes comprise small toys or other real world items such as school supplies, craft items, snacks, or gift cards. In other embodiments, prizes comprise coupons that can be redeemed for activities or privileges. For example, coupons can include activities such as a fishing trip with the child's father or having a tea party with the child's mother. In alternate embodiments, the prizes comprise privileges such as being able to invite a friend for a play date or allowing a teenager to use the family car for a date. In some embodiments, the prize can comprise a family vacation that all participants can contribute tickets towards. Prizes can also be assigned different ticket values with more valuable prizes being assigned a higher ticket value. Step 602 includes opening the store 390 regularly to allow participants to exchange tickets for prizes. In some embodiments, the organizer opens the store at a particular time and day each week. Step 603 includes exchanging tickets for prizes. The organizer collects the tickets 300 from the participants and transfers a selected prize to the participant. For higher ticket-value prizes, participant may have to save tickets 300 to be able to purchase the prizes, thereby teaching participants the value of saving and delayed gratification. In some embodiments, the prizes that have been removed from the store 390 are restocked and the exchanged tickets 300 are returned to system 100.

In one embodiment, one or more elements of the system are provided in electronic software format, including but not limited to a website, a web-based application, a smartphone application, a tablet application, a desktop application, a counter, a touch-sensitive screen application, and other similar embodiments and combinations thereof. In these embodiments, the electronic device may perform the function of one or more elements described herein.

In some embodiments, the system is provided as a kit, the kit comprising a pre-printed visual status board 110, tokens 200, and tickets 300. The kit may further comprise items to prepare participant tokens 220 and task tokens 240. The kit may include round magnetic bases 201, labels 202, and framing disks 203. The kit may further comprise pre-printed task labels 201, customizable white blank task labels 201, and colored labels 202. The kit may further comprise pre-printed 300 tickets in various denominations. The kit may also include printed instruction materials and/or video instruction materials.

In other embodiments, the kit further comprises preprinted labels 202. Preprinted labels 202 corresponding to task tokens 240 can include Family Room, Living Room, Playroom, Kitchen, Office, Loft, Bathroom 1, Bathroom 2, Hall/Stairs, Mudroom, Yard, Windows, Vacuum, Dust, Mop, Laundry, Trash/Garbage, Get Ready, Pet 1, Pet 2, Parent Choice, Car, Exercise, Budget, Cook, Iron, Journal, Pray/Scripture, and Your Bucket. Preprinted labels 202 corresponding to “FAMILY NIGHT” can include Opening Song, Opening Prayer, Conduct, Scripture, Talent, Lesson, Activity, Calendar, Closing Song, Closing Prayer, and Treat. The kit can further comprise blank labels 202 that can be used to make customized task tokens 240.

In other embodiments, the system 100 includes a membership service for parents or organizers. In some embodiments, parents or organizers that subscribe to the membership service are able to access materials from a central database of other parents or organizers that are using the system 100. Using the central database, the parents or organizers are able to join a community of other users of the system 100. In other embodiments the membership service further comprises an electronic forum of other users of the system 100. Parents and organizers are able to access instructional tutorials, advice from other users about how to adapt the system 100, advice about how to better implement the system 100, and/or about other features of the system 100. Parents and organizers are able to post, receive, and answer questions through the central database. Parents and organizers are also able to receive updates about new features, products related to the system 100, and/or frequently asked questions through the central database. In alternate embodiments, the central database is accessible through a website for parents or organizers that are subscribed to the membership service. In yet other embodiments, the membership service provides one or more elements of the system 100.

### Example

In one embodiment, the system 100 is used in a family environment with parents as the organizers and children and parents as the participants. In this embodiment, the system 100 is assembled as a kit with all of the components pre-manufactured or with some combination of pre-manufactured components and components that can be easily assembled by the parents or organizers. The kit includes a pre-manufactured visual status board 110 comprised of a ferrous metal sheet. The visual status board 110 has a pre-printed graphical grid system 120. The graphical grid system 120 is oriented such that the participant axis 130 corresponds to vertical columns and the task axis 140 corresponds to horizontal rows.

The leveling system 150 is divided into three levels 160 with the level names preprinted onto the graphical grid system 120. The first level 160 is designated as “Level One” and is placed in the uppermost row of the task axis 140. The sub-levels 170 of “Level One” are preprinted on the task axis and include “RESPONSIBILITIES,” “ROUTINE,” “BEDROOM,” “HOMEWORK,” and “PRACTICE TIME.” The second level 160 is designated as “Level Two” and is placed in the row below the first level 160. “Level Two” includes the sub-level 170 “TICKETS” that is preprinted on the task axis 140. The third level 160 is designated as the “Values” level and its label is not preprinted onto the task axis. The third level 160 is placed in the row below the second level 160 and is separated from the first two levels 160 by a preprinted line that is thicker than the other lines used on the visual status board 110. The “Values” level includes the sub-levels 170 of “GOALS,” “PROGRESS,” SERVICE,” and “FAMILY NIGHT.” The “Values” sublevels are preprinted onto the visual status board 110.

A participant token 220 is prepared for each participant by affixing a framing disk 203 in the shape of a stylized bottle cap to a base 201 that is a round magnetic disk. A small photo of the individual participant is then affixed to the framing disk 203. The process is repeated for each participant and then the participant tokens 220 are magnetically attached along the uppermost row of the graphical grid system 120 corresponding to the “Level One” row. Additional participant tokens 220 are then prepared by affixing labels 202 that are colored stickers to additional round magnetic disk bases 201. Each participant is then assigned participant tokens of a unique color. The colored participant tokens 220 are then magnetically attached along the column below the respective photo participant token 220.

Task tokens 240 are then prepared by affixing a blank or pre-printed label 202 to base 201 that is a round magnetic disk. A task token 240 for is prepared for each task or category of tasks that the participant must complete by using either a pre-printed label 202 or writing or drawing on a blank label 202. Task tokens 240 are prepared for the “RESPONSIBILITIES” sub-level 170 and include “Kitchen,” “Family Room,” “Bathroom,” “Trash/Garbage,” “Cook,” and “Yard.” The task tokens 240 are then magnetically attached along the row corresponding to “RESPONSIBILITIES” and in the participant column corresponding to the participant that is assigned that particular task. A task token 240 representing a task that all participants must complete is prepared and magnetically attached adjacent to the “Routine” sub-level 170. These tasks that all participants must complete can include “Get Ready” or “Laundry” or any other task that all participants must complete. Task tokens 240 corresponding to any additional “Level One” tasks are prepared and magnetically attached to corresponding positions on the graphical grid system 120. “Level Three” task tokens 240 are then prepared and magnetically attached in similar fashion. The task tokens corresponding to goals are prepared in similar fashion as the photo participant tokens 240 and comprise a bottle cap framing disk 203, a color coded label 202 with a task printed on the label 202, and a round magnetic disk base 201.

The task tokens 240 of the “GOALS” sub-level 170 can include “Wake up on time,” “Be kind to sister,” “Tie shoes,” “Nice hands,” “Clean closet,” and “Plant Garden.” The task tokens 240 of the “GOALS” sub-level 170 can further include “Nice Mouth” (no talking back or screaming), “Nice Words” (no naughty words), “Nice Hands” (no hitting or hurting), “Good Attitude,” “On Level Two by ______ time” (for a specific time like 9:30 p.m.), “Nice to siblings” (stop arguing and saying mean things), “Own Conversation” (do not get in the middle of others' conversations and cause problems), “Show homework” (make sure a parent sees the homework completed), “Practice Flashcards” (practice cards such as multiplication, addition, subtraction, sight words, or science words), “Body Care” (shower! Change underclothing!), “Focused Cleaning” (no whining or playing while cleaning), “Track Reading Minutes,” “Eat healthy” (No junk food), “Focused Practice” (no whining during practice time), “Stay in Bed” (during naps or bedtime), “Home on Time” (arrive home on time by curfew), “Follow family schedule”, “Use the Potty,” “Thumb out of Mouth,” “Youth Achievements” (such as Scout activities or Activity Days), “Extra-Curricular,” “Tie Shoes,” “Compliment Others,” “Electronics off at Night,” “Limit TV” (set a time limit on television viewing), “Respond first time asked,” and “Respectful answers.”

The task tokens 240 of the “FAMILY NIGHT” sub-level 170 can include, “Activity,” “Treat,” “Prayer/Scripture,” “Talent,” “Calendar,” and “Lesson.”

The kit of system 100 includes pre-printed cardboard tickets 300 in the denominations of 1, 5, 10, 25, and 50 points. The kit also includes bonus tickets 330. Bonus tickets 330 are assigned a special value by the parents.

The system 100 is used according to method of use 500. The system is used such that “Level One” corresponds to daily tasks, “Level Two” corresponds to daily tickets earned, and “Level Three” corresponds to weekly tasks that represent “Values.” At the beginning of the day, colored participant tokens 220 are inverted so that the colored labels 202 are facing down. As “Level One” tasks are completed, the colored participant tokens 240 are inverted to reveal the colored label 202 to indicate that the task has been completed. No tickets are awarded for completion of “Level One” tasks. When a participant has completed all of his or her “Level One” tasks, the participant is eligible to be rewarded with certain privileges such as watching television, playing with friends, and other suitable privileges as designated by the parents. Upon completion of all of his or her respective “Level One” tasks, the photo participant token 220 of the respective participant is moved to the respective “Level Two” row. The participant is now eligible to earn tickets. Throughout the day, parents assign certain tasks which earn tickets. As the participants complete these tasks, they earn tickets which are recorded with respective colored tokens placed on the “TICKETS” row. As the colored tokens 220 accumulate, they may be stacked to conserve space on the graphical grid system 120.

“Level Three” tasks correspond to weekly tasks that the parents assign to instill values in the participants. The parents may consult with participants in assigning these “GOALS” and assign goals based on the age and maturity level of the participant. As “GOALS” are completed, the respective task tokens 240 are inverted. The “PROGRESS” and “SERVICE” task tokens 240 are used in the same fashion. The respective “FAMILY NIGHT” task tokens 240 are inverted after a participant completes his or her task at a weekly family night activity. Parents can decide whether participants can earn tickets by completing “Level Three” tasks and also decide the amount of tickets to award for completion of individual “Level Three” tasks. In another embodiment, colored participant tokens 220 are detachably attached atop task tokens 240 to indicate completion of the respective task. In yet another embodiment, the task tokens can be removed to indicate completion of the respective task.

At the end of each day, the colored participant tokens 220 in the “TICKETS” row are exchanged for tickets for each respective participant. Then the colored participant tokens 220 corresponding to “Level One” tasks are inverted to hide the colored labels 202. Next, the “Level One” daily task tokens 240 can be shuffled to assign a task to a new participant at the parents' discretion. At the end of the week, “GOALS” and other “Level Three” tasks are assessed and reassigned as necessary. Any completed “Level Three” tasks can be exchanged for tickets at the parents' discretion.

Each week, the parents open the store 390 and allow participants to exchange tickets for real world prizes according to the method 600. During the week parents stock the store 390 with real world prizes. Parents can also stock the store with coupons that can be redeemed for activities. Parents can stock the store 390 with prizes that are adapted to the age and maturity level of the participants. For example, for small children, prizes such as colored pencils, crayons, or a coupon for a play date may be appropriate. For older children or teenagers, appropriate prizes might include the opportunity to use the family car for a date, or money to purchase clothing. Parents can elect to open the store 390 to participants on the same day and same time each week. When the store 390 is open, participants can exchange their earned tickets 300 for prizes. After participants have exchanged their tickets 300 for prizes, the store is closed until the following week. Parents then restock the store 390 with prizes.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. A motivational system for family organization, comprising:
a visual status board;
a plurality of tokens configured to interact with the visual status board wherein the tokens are configured to represent a plurality of participants, a plurality of tasks, a plurality of completion of tasks, and a plurality of tickets;
a leveling system configured to index the plurality of tasks into a plurality of levels; and
a ticket economy wherein participants earn tickets by completing tasks and wherein participants exchange tickets for prizes,
wherein the visual status board is further configured to interact with the plurality of tokens to continuously track the plurality of participants, the plurality of tasks, the plurality of completions of tasks, and the plurality of tickets.

2. The system of claim 1, wherein the visual status board further comprises:
a ferrous metal sheet configured to attract magnetic materials; and
a graphical grid system.

3. The system of claim 2, wherein the plurality of tokens further comprises:
a magnetic base configured to attract ferrous metal; and
a label.

4. The system of claim 1, wherein the leveling system is configured into a plurality of levels wherein a participant must complete the tasks of a lower level before completing the tasks of subsequent levels.

5. The system of claim 4, wherein the plurality of levels are configured into three levels corresponding to daily tasks, tickets earned by participants, and values.

6. The system of claim 5, wherein the plurality of levels are further divided into sub-levels configured to index specific categories of tasks;
wherein the level corresponding to daily tasks indexes the categories of responsibilities, routine, bedroom, homework, and practice; and
wherein the level corresponding to values indexes the categories of goals, progress towards goals, service activities, and family night activities.

7. The system of claim 1, wherein the ticket economy further comprises a store stocked with prizes comprising real world items or coupons for activities.

8. The system of claim 1, wherein one or more of the elements of the system comprise an electronic software format.

9. The system of claim 1, wherein the system further comprises providing a web-based membership service to allow a user of the system to access instructional materials about the system.

10. The system of claim 9, wherein the web-based membership service allows the user to communicate with other users about the system.

11. A method for motivating a participant, comprising:
providing a visual status board;
providing a plurality of tokens configured to interact with the visual status board wherein the tokens are configured to represent a plurality of participants, a plurality of tasks, a plurality of completion of tasks, and a plurality of tickets;
providing a leveling system configured to index the plurality of tasks into a plurality of levels;
providing a ticket economy wherein participants earn tickets by completing tasks and wherein participants exchange tickets for prizes;
tracking the plurality of participants, the plurality of tasks, the plurality of completions of tasks, and the plurality of tickets by manipulating the interaction of the plurality of tokens with the visual status board;
allocating tickets to participants; and
redeeming tickets for prizes.

12. The method of claim 11 wherein the method further comprises providing the visual status board comprised of:
a ferrous metal sheet configured to attract magnetic materials; and
a pre-printed, graphical grid system.

13. The method of claim 12 wherein the method further comprises providing the plurality of tokens further comprised of:
a magnetic base configured to attract ferrous metal; and
a label.

14. The method of claim 11, wherein the leveling system is configured into a plurality of levels wherein a participant must complete the tasks of a lower level before completing the tasks of subsequent levels.

15. The method of claim 11, wherein the ticket economy further comprises a store stocked with prizes comprising real world items or coupons for activities.

16. The method of claim 11, wherein the method further comprises providing one or more of the elements of the system in an electronic software format.

17. The method of claim 11, wherein the method further comprises providing a web-based membership service to allow a user of the system to access an electronic forum of users of the system.

18. A kit for a motivational system for family organization, comprising:
a visual status board;
a plurality of tokens configured to interact with the visual status board wherein the tokens are configured to represent a plurality of participants, a plurality of tasks, a plurality of completion of tasks, and a plurality of tickets; and
a plurality of tickets,
wherein the visual status board is further configured to interact with the plurality of tokens to continuously track the plurality of participants, the plurality of tasks, the plurality of completions of tasks, and the plurality of tickets.

19. The kit of claim 18, wherein the visual status board further comprises:
a ferrous metal sheet configured to attract magnetic materials; and
a graphical grid system.

20. The kit of claim 18, wherein the plurality of tokens further comprises:
a magnetic base configured to attract ferrous metal; and
a label.
